(19) United States
(12) Patent Application Publication
(10) Pub. No.: US 2020/0082429 A1
(43) Pub. Date: Mar. 12, 2020

(54) PAYMENT SELECTION SYSTEMS AND METHODS

(71) Applicant: Venkata Naga Pradeep Kumar Kaja, Foster City, CA (US)

(72) Inventor: Venkata Naga Pradeep Kumar Kaja, Foster City, CA (US)

(21) Appl. No.: 16/128,833

(22) Filed: Sep. 12, 2018

(51) Int. Cl. G06Q 30/02; G06Q 20/40; G06Q 20/22; G06Q 20/30

(52) U.S. Cl. CPC G06Q 30/0233; G06Q 20/30; G06Q 20/227; G06Q 20/4014

(57) ABSTRACT

A processor-implemented method for payment selection. The method comprises receiving user identifying information associated with a user and payment account information associated with a plurality of user payment accounts associated with the user. The method includes receiving transaction request information for a transaction including the user identifying information and the payment account information for a first user payment account. The method includes determining a first potential benefit from completing the transaction using the first user payment account and a second potential benefit from completing the transaction using a second user payment account. The method includes determining that the second potential benefit is greater than the first potential benefit, completing the transaction with the second of the plurality of user payment accounts.

### FIELD OF THE INVENTION

The invention relates to systems and methods for managing payment account programs.

### BACKGROUND

Many payment accounts offer various loyalty or rewards programs to incentivize consumers to use their respective payment accounts for making purchases. For example, a credit card company may offer rewards points to its users based upon the amount of dollars spent through transactions using that company's credit card. Many other payment accounts may also offer rewards, such as bank debit cards, retailers that offer rewards cards, or even groups of retailers or other merchants offering shared rewards. Some credit or debit card issuers may offer various different types of rewards programs that offer bonus points for certain types of purchases, such as airline tickets, hotels, gasoline, restaurants, groceries, etc. Some rewards programs may even offer different bonus rewards multipliers from week to week, or from month to month.

A single user may sign up with more than one of payment account, for which the user may receive multiple cards. Traditionally, a user would need to decide which payment account to use for each new transaction, often unaware of what particularly rewards or points are available for each separate payment account. A system is needed that will help users more effectively take advantage of their various payment account programs.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In some embodiments, the disclosure describes a processor-implemented method for payment selection. The method may comprise receiving user identifying information associated with a user from a user device, and receiving payment account information associated with a plurality of user payment accounts associated with the user. A first of the plurality of user payment accounts may be associated with a first account program and a second of the plurality of user payment accounts may be associated with a second account program. The method may also include receiving transaction request information, which may include the user identifying information of the user and the payment account information for the first of the plurality of user payment accounts. Based on the user identifying information, the method may include determining a first potential benefit and a second potential benefit. The method may include determining that the second potential benefit is greater than the first potential benefit. Based on the determination that the second potential benefit is greater than the first potential benefit, the method may include transmitting a confirmation request to the user device. The confirmation request may be configured to request that the user confirm that the transaction be completed using the second of the plurality of user payment accounts instead of the first of the plurality of user payment accounts. The method may include receiving a selection of the user to complete the transaction using the second of the plurality of user payment accounts instead of the first of the plurality of user payment accounts. Based on receiving the selection of the user, the method may include completing the transaction with the second of the plurality of user payment accounts.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 is an illustration of the elements of an embodiment of a system that includes a system for monitoring and preventing fraud as disclosed herein;

FIG. 2 is a schematic illustration of elements of an embodiment of an example computing device;

FIG. 3 is a schematic illustration of elements of an embodiment of a server type computing device;

FIG. 4 is a block diagram illustrating system elements for an embodiment of a payment selection system in accordance with the current disclosure;

FIG. 5 is a user interface diagram illustrating example features of an embodiment of a user interface for the payment selection system as described herein;

FIG. 6 is a flow chart of an embodiment of a process for selecting payments using the payment selection system described herein; and

FIG. 7 is a flow chart of another embodiment of a process for selecting payments using the payment selection system described herein.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DETAILED DESCRIPTION

The present invention now will be described more fully hereinafter with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

The payment selection system and methods described herein may provide a user of multiple payments accounts an efficient way to maximize the rewards received through one or more payment account programs for a given purchase or other transaction. For example, a user may have various payment accounts, each corresponding to a points or rewards program. The transaction may be any type of non-cash transaction, such as credit card, card-on-file (COF), e-commerce, tokenized, etc. Each rewards account program may accumulate rewards points for each purchase made using the program's respective payment account. Often, however, at the time of a particular purchase or other transaction, a user may be unaware of the loyalty or other rewards points they have in any particular account, or what type of rewards may be earned with a given transaction. Traditionally, this would mean a user may use a card or other payment account at random without knowing the loyalty points that could be earned by using a different account. In some embodiments, the payment selection system may allow a user to take advantage of the rewards from their rewards programs even if they may not be aware of those points or initiate a transaction with the specific card or account linked to those rewards points.

The payment selection system may, in some embodiments, include a first step of enrolling a user in the payment selection system. In such embodiments, the payment selection system may collect uniquely identifiable details about the user, such as a phone number, email address, etc., and a unique device identifier from which the user may receive and respond to notifications about a particular transaction. The user may, in some embodiments, use the same details and device identifiers for each of the payment accounts enrolled with the payment selection system. The payment selection system may then link the uniquely identifiable user detail and device identifier with each of the payment accounts or payment cards of the user that have been enrolled with the payment selection system. In some embodiments, the user's accounts may be linked to the user details by linking all of the user's tokens or permanent account numbers (PANs) so that the payment selection system may identify the list of payment accounts and/or tokens the user has provided. Thus, the payment selection system may have a unique user identifier that it may link to each of the user's payment accounts.

Some embodiments may then include a second step that occurs when the user makes a specific transaction. During the transaction, a user device or a merchant system or server may transmit identifying information, such as a token reference identification for a tokenized PAN, an actual PAN, or other information allowing the payment selection system to identify the user. Once the user is identified, such as by obtaining the user's individual PAN or token during the payment, the payment selection system may identify the unique user detail and device identifier through which the user enrolled with the payment selection system in the first step and, accordingly, identify each of the payments enrolled for the user. The payment selection system may also receive identifying information about the merchant with which the user is transacting. The payment selection system may then, in some embodiments, determine what offers may be available for each of that user's enrolled payment accounts. For example, the payment selection system may identify loyalty/rewards points available for the purchase by searching a database, or may contact the issuers or other entities running each payment account and determine the available rewards, if any, for the corresponding bank identification number (BIN) range or merchant. In some embodiments, the payment selection system may contact the merchant directly to request information of any current offers for the corresponding issuers or other payment account hosts. The payment selection system may then combine the data received regarding offers or other rewards point information to determine the best purchasing option for the user.

In some embodiments, once the payment selection system has determine the best payment account option for the user for a particular transaction, the payment selection system may send a notification to a user device using, for example, the device identifier received during enrollment. In some embodiments, the notification may alert the user that a payment account other than the account the user initially chose for the transaction would result in better rewards or offers for the user. The user may then determine whether to authorize the payment selection system to change the payment account used for the transaction via the user device. In some embodiments, the notification may display to the user the benefits of using another payment account. In some embodiments, the payment selection system may automatically change the payment account used for the transaction based on the benefits without contacting the user for authorization each transaction. In some embodiments, once the user has authorized the change in payment accounts, the payment selection system may reach out to the issuer of the selected account and request an open authorization (OAuth) and proceed with the transaction.

In a general example, a first rewards account program associated with a first user payment account may offer different rewards for a given transaction than a second rewards account program associated with a second user payment account. For a given transaction, it may be difficult for the user to know or to easily find out what sort of rewards each of the first and second rewards account programs may include. The payment selection system may, in some embodiments, determine which of the user's rewards program accounts or combination of rewards program accounts would provide the user with the greatest rewards. The system may then, either automatically or upon additional prompting from the user, select the payment account with the greatest rewards to use for that particular purchase, regardless of what payment account the user initially selects. For example, the user may use a credit card issued for the first user payment account either online or in a store. If the system determines that the second rewards account program associated with the second user payment account will provide a more advantageous reward than the first account rewards program, the system may change the payment account that is used for the given transaction in order to earn the corresponding rewards or points. Accordingly, the system may, among other things, provide a technical solution to the problem of imperfect knowledge of rewards accounts and a technical problem of the inability to readily access rewards information for multiple different payment accounts.

At a high level, in an embodiment, the disclosure describes a processor-implemented method for payment selection. The method may comprise receiving, via a digital communication network, user identifying information associated with a user from a user device, and receiving, via the digital communication network, payment account information associated with a plurality of user payment accounts associated with the user. A first of the plurality of user payment accounts may be associated with a first account program and a second of the plurality of user payment accounts may be associated with a second account program. The method may also include receiving, via a payment network, transaction request information for a transaction. The transaction request information may include the user identifying information of the user and the payment account information for the first of the plurality of user payment accounts. Based on the user identifying information, the method may include determining, via one or more processors a first potential benefit through the first account program from completing the transaction using the first of the plurality of user payment accounts, and a second potential benefit through the second account program from completing the transaction using the second of the plurality of user payment accounts. The method may include determining, via the one or more processors, that the second potential benefit is greater than the first potential benefit. Based on the determination that the second potential benefit is greater than the first potential benefit, the method may include transmitting, via the digital communication network, a confirmation request to the user device. The confirmation request may be configured to request that the user confirm that the transaction be completed using the second of the plurality of user payment accounts instead of the first of the plurality of user payment accounts. The method may include receiving, via the digital communication network, a selection of the user to complete the transaction using the second of the plurality of user payment accounts instead of the first of the plurality of user payment accounts. Based on receiving the selection of the user, the method may include completing the transaction with the second of the plurality of user payment accounts.

In another embodiment, the disclosure describes a processor-implemented method for payment selection. The method may include receiving, via a digital communication network, user identifying information associated with a user. The method may include receiving, via the digital communication network, payment account information associated with a plurality of user payment accounts associated with the user. The method may also include receiving, via a payment network, transaction request information for a transaction. The transaction request may include information including the user identifying information of the user and the payment account information for a first of the plurality of user payment accounts. Based on the user identifying information, the method may include determining, via one or more processors, a first potential benefit from completing the transaction using the first of the plurality of user payment accounts, and a second potential benefit from completing the transaction using a second of the plurality of user payment accounts. The method may also include determining, via the one or more processors, that the second potential benefit is greater than the first potential benefit. Based at least partially on the determination that the second potential benefit is greater than the first potential benefit, the method may include completing the transaction with the second of the plurality of user payment accounts.

In another embodiment, the disclosure describes a processor-implemented method for payment selection. The method may include receiving, via a digital communication network, user identifying information associated with a user, and receiving, via the digital communication network, a user device identifier associated with a user device of the user. The method may include receiving, via the digital communication network, payment account information associated with a plurality of user payment accounts associated with the user. The method may include receiving, via a payment network, transaction request information for a transaction. The transaction request information may include the user identifying information of the user and payment account information for an initial user payment account of the plurality of user payment accounts. Based on the user identifying information, the method may include determining, via one or more processors, a potential benefit available for completing the transaction with each of the plurality of user payment accounts. The method may include determining, via the one or more processors, a best user payment account of the plurality of user payment accounts. The best user payment account having a greater potential benefit than the potential benefit of the initial user payment account. Based at least partially on the determination that the potential benefit of the best user payment account is greater than the potential benefit of the initial user payment account, the method may include completing the transaction with the best user payment account of the plurality of user payment accounts.

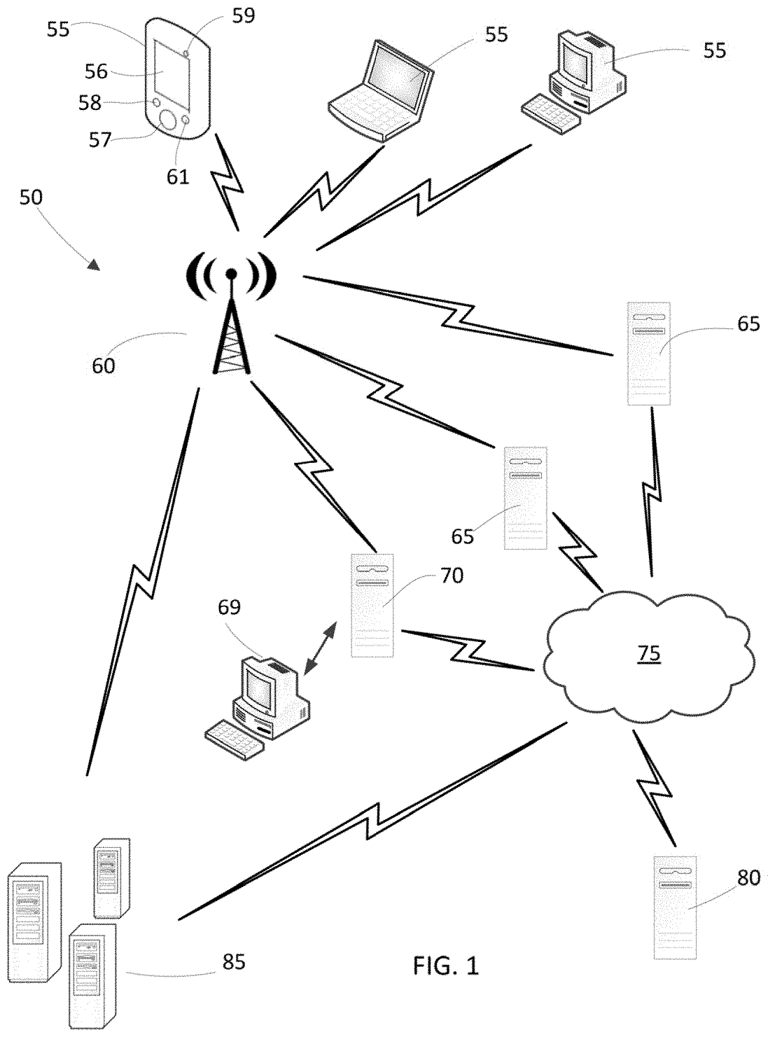

A high level illustration of some of the elements in a sample computing system 50 that may be physically configured to implement the payment selection system and process is illustrated in FIG. 1. The system 50 may include any number of computing devices 55, such as smart phones or tablet computers, mobile computing devices, wearable mobile devices, desktop computers, laptop computers, or any other computing devices that allow users to interface with a digital communications network, such as digital communication network 60. Connection to the digital communication network 60 may be wired or wireless, and may be via the internet or via a cellular network or any other suitable connection service. Various other computer servers may also be connected to via the digital communication network 60, such as a merchant server 70, a payment server 85, one or more issuer servers 65 and a token server 80. The merchant server 70 may also be connected, either directly or over the digital communication network 60, to one or more point-of-sale (POS) devices 69, such as in a merchant store. The payment server 85 may represent, for example, a credit card issuer, a bank, or another financial institution. Various of these servers or computer entities may also be connected through a secure payment network 75. The payment network 75 may be an electronic payment system used to accept, transmit, or process transactions made by users with payment cards for money, goods, or services, and to transfer information and funds among payment card issuers, merchants, payment card holders, payment processors, acquirers, etc. In the illustrated embodiment, at least the merchant server 70, the token server 80, and the payment server 85, and the one or more issuer servers 65 may be connected via the payment network 75, but it is contemplated that other entities, such as the an acquirer, may be connected as well. It is also contemplated that the payment server 85 may also be connected to the one or more user devices 55 over the digital communication network 60.

In one embodiment, the computing device 55 may be a device that operates using a portable power source, such as a battery. The computing device 55 may also have a display 56 which may or may not be a touch sensitive display. More specifically, the display 56 may have a capacitance sensor, for example, that may be used to provide input data to the computing device 55. In other embodiments, an input pad 57 such as arrows, scroll wheels, keyboards, etc., may be used to provide inputs to the computing device 55. In addition, the computing device 55 may have a microphone 58 which may accept and store verbal data, a camera 59 to accept images and a speaker 61 to communicate sounds.

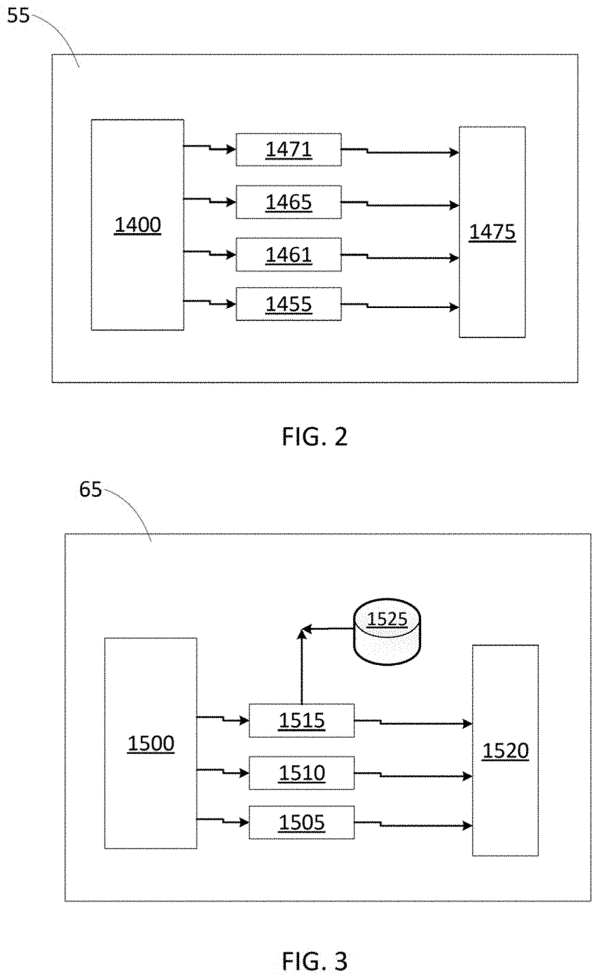

FIG. 2 is a simplified illustration of the physical elements that make up an embodiment of a computing device 55 and FIG. 3 is a simplified illustration of the physical elements that make up an embodiment of a server type computing device, such as the payment server 85, but the merchant server 70, the issuer servers 65, and the token server 80 may reflect similar physical elements in some embodiments. Referring to FIG. 2, a sample computing device 55 is illustrated that is physically configured according to be part of the computing system 50 shown in FIG. 1. The portable computing device 55 may have a processor 1451 that is physically configured according to computer executable instructions. In some embodiments, the processor can be specially designed or configured to optimize communication between the server 85 and the computing device 55 relating to the payment selection service described herein. The computing device 55 may have a portable power supply 1455 such as a battery, which may be rechargeable. It may also have a sound and video module 1461 which assists in displaying video and sound and may turn off when not in use to conserve power and battery life. The computing device 55 may also have volatile memory 1465 and non-volatile memory 1471. The computing device 55 may have GPS capabilities that may be a separate circuit or may be part of the processor 1451. There also may be an input/output bus 1475 that shuttles data to and from the various user input/output devices such as a microphone, a camera 59, a display 56, or other input/output devices. The portable computing device 55 also may control communicating with the networks, such as communication network 60 in FIG. 1, either through wireless or wired devices. Of course, this is just one embodiment of the portable computing device 55 and the number and types of portable computing devices 55 is limited only by the imagination.

The physical elements that make up an embodiment of a server, such as the payment server 85, are further illustrated in FIG. 3. In some embodiments, the payment server is specially configured to run the payment selection service as described herein. At a high level, the payment server 85 may include a digital storage such as a magnetic disk, an optical disk, flash storage, non-volatile storage, etc. Structured data may be stored in the digital storage such as in a database. More specifically, the server 85 may have a processor 1500 that is physically configured according to computer executable instructions. In some embodiments, the processor 1500 can be specially designed or configured to optimize communication between a portable computing device, such as computing device 55, and the server 85 relating to the payment selection service as described herein. The server 85 may also have a sound and video module 1505 which assists in displaying video and sound and may turn off when not in use to conserve power and battery life. The server 85 may also have volatile memory 1510 and non-volatile memory 1515.

A database 1525 for digitally storing structured data may be stored in the memory 1510 or 1515 or may be separate. The database 1525 may also be part of a cloud of servers and may be stored in a distributed manner across a plurality of servers. There also may be an input/output bus 1520 that shuttles data to and from the various user input devices such as a microphone, a camera, a display monitor or screen, etc. The input/output bus 1520 also may control communicating with the networks, such as communication network 60 and payment network 75, either through wireless or wired devices. In some embodiments, a payment selection controller for running the payment selection service may be located on the computing device 55. However, in other embodiments, the payment selection controller may be located on payment server 85, or both the computing device 55 and the server 85. Of course, this is just one embodiment of the payment server 85 and additional types of servers are contemplated herein.

In the embodiment illustrated in FIG. 1, the payment server 85 may be connected to the merchant server 70 either through the digital communication network 60, through the payment network 75 or through other connections. In some embodiments, the merchant server 70 may be associated with any type of merchant offering goods or services for purchase with payment cards, whether those purchases are online or otherwise. For online purchases, the merchant server 70 or a group of servers may host a merchant website where the merchant's goods or services may be purchases by a user. In some embodiments, the payment selection system may collect payment information from the user, such as payment card credentials, that may be used for the immediate transactions as well as for future purchases with the same or other merchants as further described herein. As such, the payment selection system may consolidate the entities to which a user shares its confidential payment information. Specifically, the user may share its payment card information with the payment selection system via software or other interface hosted by the system, and payment selection system store the payment and other account information for use in future purchases. In some embodiments, the payment selection system may also store information regarding rewards points or loyalty programs associated with the stored payment accounts. The payment selection system may also be in contact with other payment account issuers to receive up-to-date information regarding the details of associated rewards points or loyalty programs.

In some embodiments, the payment selection system may be hosted on or otherwise run by the payment server 85. In some embodiments, the payment selection system may be hosted by another entity, such as an issuer using an issuer server 65 or a merchant using a merchant server 70. In some embodiments, a user may access the payment server 85 via a computing device 55 such as a smartphone, and may set up an account with the payment selection system. The user may provide payment account or banking information for one or more payment cards provided by one or more card issuers or associated with one or more merchants. One or more of the payment accounts may be associated with an account program, such as a rewards program or loyalty program. The payment selection system may store such payment account information associated with the user's account that can be retrieved at the user's request to complete e-commerce transactions. Purchases using payment information stored with the payment selection system, however, may occur in any of a variety of ways. In some embodiments, the user may select a payment account or card stored through the payment selection system for use performing a given transaction. As described in more detail below, the payment selection system may determine which of a user's payment accounts to use for a given transaction based on the rewards points available.

The computing device 55 may be able to communicate with a computer server or a plurality servers, such as the payment server 85, the merchant server 70, and issuer servers 65. The computing device 55 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the server or may be through a digital communication network 60 such as cellular service, through the Internet, through a private network, through Bluetooth, etc.

In some embodiments, the payment servers 85 may be associated with the payment selection system, and may send and receive information to and from a user device 55 associated with the user payment accounts of a user. Specifically, software may be included on the user computing device 55 allowing notifications to be received from the payment selection system via the digital communications network 60. In some embodiments, the software may be an application through which a user may complete transactions, such as banking, money transfer, merchant purchases, etc. In some embodiments, the software may be an add-on to a web browser included on the user computing device 55. In some embodiments, the payment selection system's software may be an application installed on the user computing device 55 that allows for the use of other applications on the user computing device, such as applications provided by a bank, online merchant, email service, payment provider, etc. In yet other embodiments, the payment selection service provide notifications using software native to the user computing device 55, such as SMS messaging or other notifications. In such embodiments, the payment selection system may send notifications to the user device 55 regarding payment selection determinations, such as are described in further detail below.

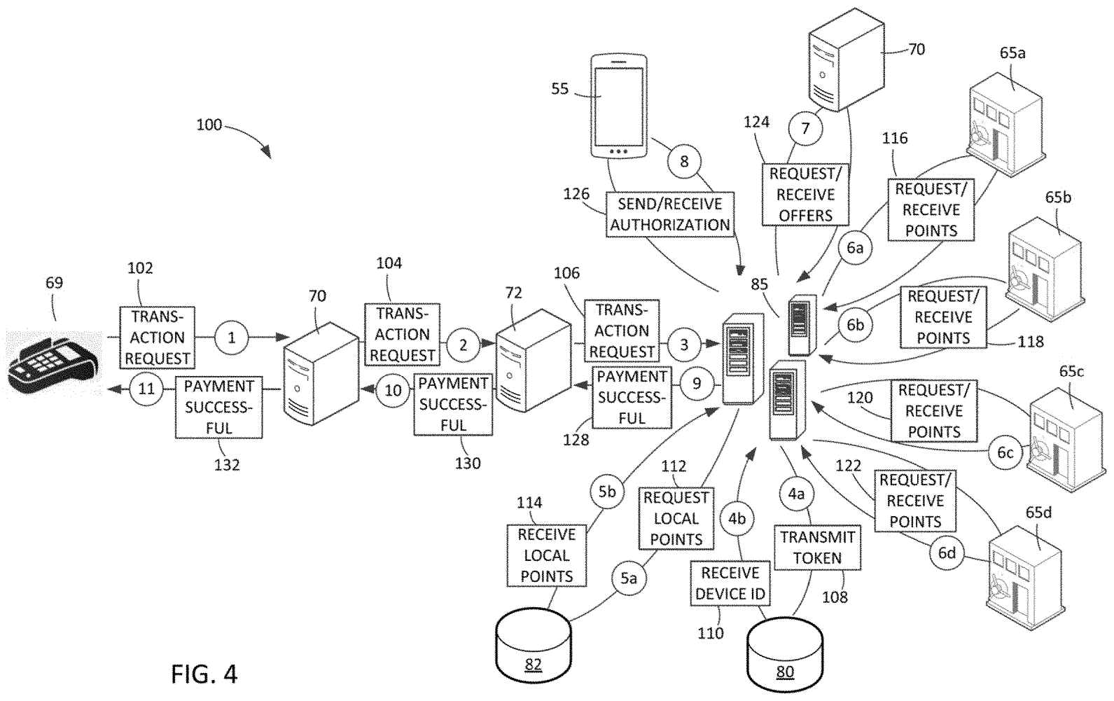

FIG. 4 is a data flow diagram generally illustrating an embodiment 100 of a payment selection system 100 that may determine which of a plurality of user payment accounts to use for a transaction. In some embodiments, a user may initiate a transaction in any of a variety of ways, e.g., swiping or inserting a credit card at a merchant POS, tapping an electronic payment device against a POS terminal 101, selecting a payment account during an online e-commerce transaction, etc. In the case of an e-commerce transaction, the POS terminal 101 may be a user's personal computing device, such as a smart phone or computer. At 102, the POS terminal or other computing device may add processing options data object lists (PDOL) data to the transaction along with the media access control (MAC) address and token details gleaned from the payment device and transmit this data as a transaction request to the merchant server 103 or computer. At 104, the merchant server may forward this transaction request and accompanying data on to an acquirer server 72 of an acquirer of the merchant. At 106, the acquirer server 72 may transfer the transaction request data to the payment server or servers 85 hosting the payment selection system. The payment selection system may then identify the token or other identifying information transmitted in the transaction request. For example, in embodiments in which a token is transmitted with the transaction request, at 108, the payment selection system may transmit the token to a token server 80. In some embodiments, the token server 80 may include a database of user tokens corresponding to device identifiers for those users, such as for the user device identifier and unique user identifier enrolled during the enrollment process with the payment selection system. The token server 80 may also include a list of payment accounts or other tokens for payment accounts or credit cards enrolled by the user with the payment selection system. At 110, the payment server 85 may receive the requested device identifier and payment account information from the token server 80.

In some embodiments, the entity associated with the payment selection system may also be associated with payment accounts or credit cards with which users may have accounts. These accounts may, in turn, include account programs that involve rewards and/or loyalty points. In such embodiments, at 112, the payment selection system may instruct the payment server 85 to request a local loyalty points provider 82 to determine loyalty or rewards points available to the user for the particular transaction. At 114, the payment server 85 may receive information reflecting the rewards points available for the transaction in the transaction request in the local account program. In some embodiments, the payment selection system may need to contact issuer servers 65a-65d for some or each of the payment accounts for which the user has enrolled. For example, in the embodiment illustrated in FIG. 4, the user in question may have enrolled with four payment accounts through four issuers with issue servers 65a-d. In such embodiments, the payment selection system may, at 116, 118, 120, and 122, to instruct the payment server 85 to request the cards or accounts the user has at each respective issuer based on the token server data. The payment server 85 may then receive rewards points data for each respective account program at each respective issuer from the issue servers 65a-d. It should be understood that, although four additional issuers are shown in FIG. 4, any number of issuers or user payment accounts are contemplated.

At 124, the payment selection system may instruct the payment server 85 to transmit a request rewards points data or other offer data to the merchant server 70. In some embodiments, the merchant involved in the specific transaction may have offers or rewards corresponding to a loyalty program or some other account program. In some embodiments, the merchant involved in the requested transaction may have offers or other benefits in place related to transaction completed with specific issuers of payment accounts. Upon receiving rewards points data and other offer information from the merchant server 70, the payment selection system may determine the best user payment account to use for the requested transaction based on the points data received from the issuer servers 65a-d and the merchant server 70. It should be understood that the best user payment to use for any given transaction may be based on a variety of criteria that may be customizable by a user. For example, in some embodiments, a user may identify preferences, upon enrollment or otherwise, regarding preferences for which user payment accounts to use based on the points available for particular transactions. For example, a user may provide a preference for a certain payment account unless the reward points exceed a certain pre-determined threshold amount. In other embodiments, the user may indicate a pre-determined payment account to use for transactions above or below a certain amount, or for certain types of transactions (e.g., restaurants, sports equipment, gasoline, etc.).

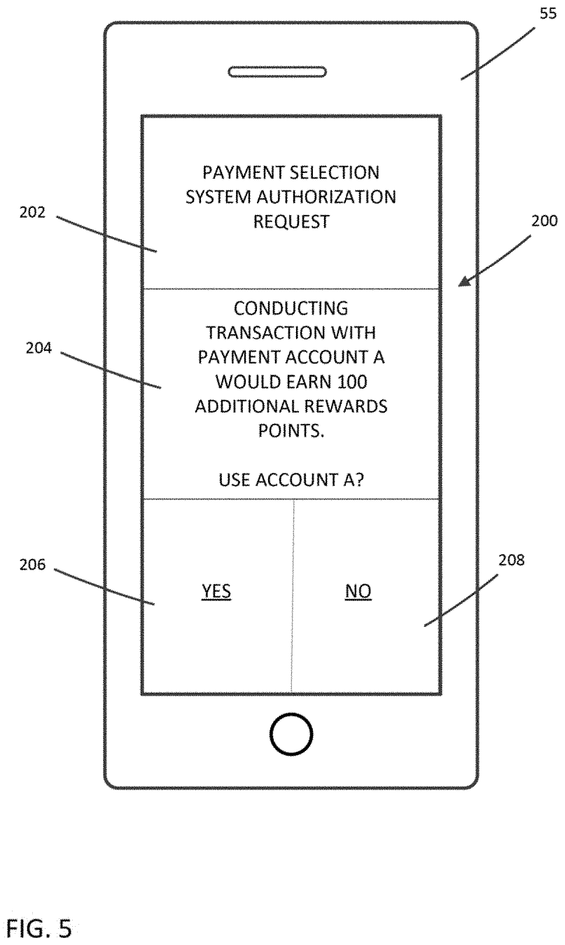

At 126, in some embodiments, the payment selection system may instruct the payment server 85 to transmit an authorization request to a user computing device 55 associated with the user's enrollment. The authorization request may result in a notification being displayed on the user computing device. An example of a graphical user interface (GUI) 200 with such an identification on an example user computing device 55 is shown in FIG. 5. The GUI may include an alert banner 202, a rewards banner 204, and response buttons 206, 208. The alert banner 202 may include information directed to the user to indicate, for example, the source of the request. The rewards banner 204 may include information regarding the amount of rewards points that may be earned by authorizing the best payment account determined by the payment selection system, and may include the amount of additional rewards points that may be earned. In some embodiments, the rewards points awarded through a first payment account program and a second payment account program may not be directly comparable. In such embodiments, the user may include pre-determined weighting to give points from each program account. In some embodiments, the GUI 200 may additionally include details of the rewards points that may be accrued based on the payment account chosen by the user to initiate the transaction as well as the rewards points for the best payment account program determined by the system. The GUI may include a YES button 206 to indicate that the user would like to select the new account the system has determined best, and a NO button 208 to decline using the account the system has determined as best. In some embodiments, if the user indicates the NO button 208, the payment selection system may revert to using the payment account used by the user to initiate the transaction. It should be understood by those skilled in the art that the GUI shown in FIG. 5 is exemplary only, and that other GUI configurations may be used.

In some embodiments, the user may complete authorization for using the new payment account using one of a variety of biometric technologies. For example, the user may provide or an application may require a user to verify the user's identify in order for the system to approve the selection of the new payment account. In some embodiments, the identify verification may be made using fingerprint scanners on a mobile device or computing device, retina scans, facial recognition, voice recognition, or any other suitable identification verification technology. In some embodiments, the system may request that the user enter a pre-established password or number combination in order to authorize a payment account change.

In some embodiments, the system may also or alternatively request a notification via SMS or another suitable text messaging system. Such embodiments may be particularly useful when a user's computing device does not have sufficient network connection to receive network-based notifications. In such embodiments, the user may simply reply to the SMS message with, for example, a “Yes” or “No” response, or a number “1” for yes, or “2” for no, or any other suitable text authorization. In some embodiments, authorization verification may be the primary source of user authorization, or may be an alternative source of user authorization if the system determines that a user's computing device has not received another network or internet based notification.

Referring again to FIG. 4, once a user has made a selection to use the user payment account suggested by the payment selection system or to decline and use the originally initiated user payment account, the payment server 85 may receive the selection from the user computing device 55. In some embodiments, the payment selection system may include a predetermined authorization time limit for which the system will wait to receive a selection from the user computing device 55 before moving forward with a transaction. For example, in some embodiments, the payment selection system may wait one minute for a response from the user computing device 55. In other embodiments, the payment selection system may wait thirty seconds, or two minutes, or three minutes in other embodiments. Those skilled in the art will understand that any suitable authorization time limits may be used. In some embodiments of the system, the user may select that, upon expiration of the authorization time limit, the system will proceed with the transaction using the best payment account suggested by the payment selection system. In other embodiments, the user may select that the system proceed with the payment account originally chosen by the user in initiating the transaction. In yet other embodiments, the payment selection system may proceed with the requested transaction using the best payment account determined based on rewards points automatically without requesting or receiving authorization from the user at all.

In some embodiments, upon receiving the authorization from the user computing device 55, the payment selection system may request and receive authorization to charge from the issuer of the chosen payment account to proceed with the transaction. For example, the payment selection system may request and receive an OAuth for the requested transaction using the best payment account as determined by the system. At 128, the payment selection system may instruct the payment server 85 to transmit a payment successful notification to the acquirer server 72. At 130, the acquirer server 72 may then transmit a payment successful notification to the merchant server 70, which may, at 132, transmit a payment successful notification to the POS 69, or to the user computing device used to initiate the transaction.

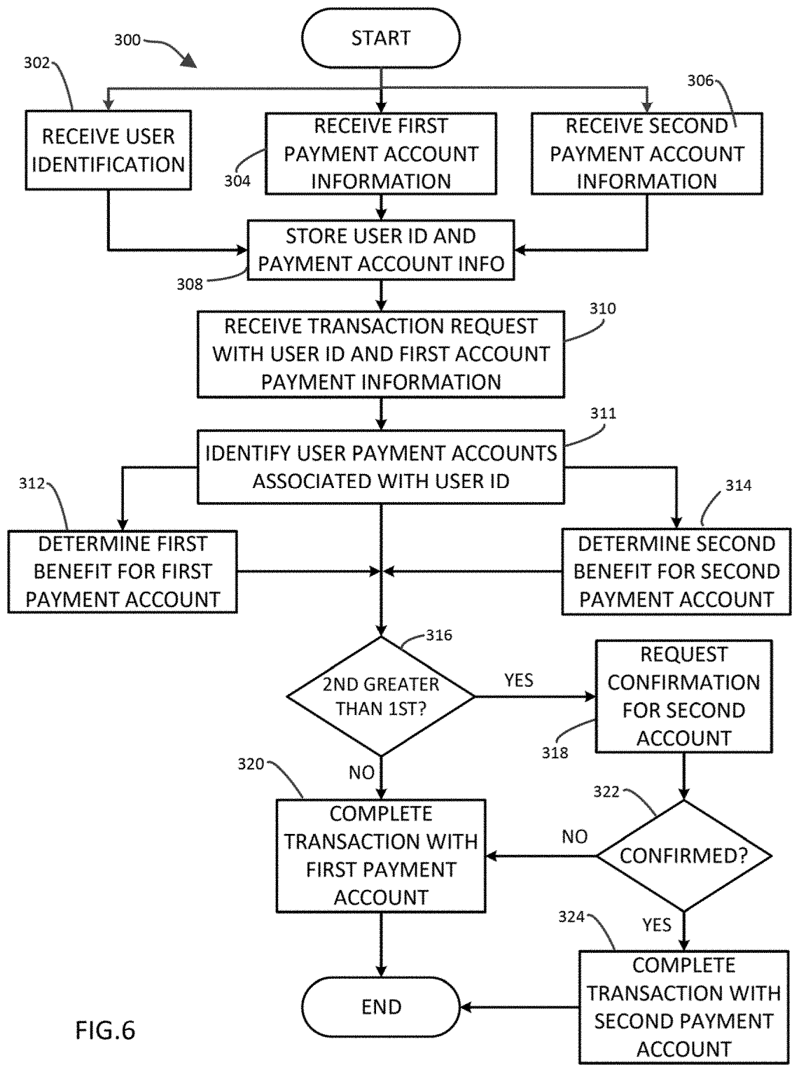

FIG. 6 is a flowchart 300 of an embodiment of a method of using the payment selection system as shown and described herein. At 302, the system may receive user identifying information associated with a user from a user computing device, for example, via digital communication network 60. In some embodiments, the payment selection system may also receive one or more user device identifiers, such as a telephone number, IP address, etc., that may allow the payment selection system to identify a unique user computing device 55. The payment selection system may receive payment account information for a plurality of user accounts, including a first of the plurality of user accounts at 304 and a second of the plurality of user accounts at 306. In some embodiments, the first of the plurality of user accounts may be associated with a first account program, and the second of the plurality of user accounts may be associated with a second account program. Although only two user payment accounts associate with two account programs are included in FIG. 6, it should be understood that any number of payment accounts may be used, with any number of account programs. In some embodiments, the account programs may be loyalty or rewards points programs in which a user may earn points, for example, by completing transactions using the payment account associated with the account program.

In some embodiments, the payment selection system may, at 308, store the user identifying information and payment account information associated with the plurality of user payment accounts. In some embodiments, this information may be stored on the payment server 85. In some embodiments, the information may be stored in a token server 80, and accessible by the payment server 85 when presented with a token associated with the user identifying information. In such embodiments, the user computing device 55 may store a token upon enrollment with the payment selection system, and/or the user identifying information may be associated with a token in the payment selection system. Accordingly, in some embodiments, when the payment selection system receives user identifying information, the information may be associated with a token, which may be used to extract user payment account information, device identifiers, or other user information from the token server 80.

At 310, the payment selection system may receive a transaction request that may include user identifying information and payment information for the first user payment account of the plurality of user payment accounts. In some embodiments, as described in reference to FIG. 4, the transaction request may originate from a variety of sources, such as a POS device at a merchant, a user computing device, an e-commerce platform, etc. In some embodiments, the transaction request may be transmitted through a merchant server 70 and an acquirer server 72, and on to a payment server 85. In some embodiments, the transaction request may include user identifying information and payment account information for the first of the plurality of user payment accounts. In some embodiments, the user identifying information may be token reference ID for a tokenized PAN, an actual PAN, a username, a user device identifier, or any other suitable identification data. At 311, the payment selection system may identify the plurality of user payment accounts associated with the user identifying information in the transaction request. In some embodiments, the payment server 85 may query an internal database, or may query the token server 80 in other embodiments to retrieve a list of payment accounts associated with the user identifying information. In some embodiments, the first user payment account and the second user payment account may be identified by the payment selection system, although additional accounts may be identified as well. The payment selection system may determine whether each of the first and second user payment accounts are associated with account programs, such as rewards or loyalty points programs. In some embodiments, the first user payment account may be associated with a first account program and the second user payment account may be associated with a second account program.

At 312, the payment selection system may determine a first potential benefit for completing the requested transaction with the first payment account, and at 314, the payment selection system may determine a second potential benefit for completing the requested transaction with the second payment account. In some embodiments, the first and second potential benefits may be the reward points awarded to the user for using the first or second payment accounts, respectively, to complete the requested transaction. It is contemplated, however, that reward points for an account program may come in many forms, such as miles, points, currency, product or sales offers, etc. As shown and described with reference to FIG. 4, the payment selection system may determine the potential benefits for each of the account programs in a variety of ways. For example, in some embodiments, the payment selection system may query a local loyalty provider 82 for local rewards points, or may query other payment account or credit card issuers 65a-d to determine the potential benefits associated with other account programs of corresponding with user payment accounts.

Once all of the potential benefits for each of the account programs associated with each of the identified plurality of user payment accounts have been determined, the payment selection system may compare at least the first potential benefit with the second potential benefit to determine which of the account programs would result in a better benefit to the user if the associated user payment account were to be used to complete the requested transaction. In some embodiments, comparing the plurality of potential benefits may include comparing the rewards points that would be awarded based on the requested transaction by each respective account program. In some embodiments, the rewards points may be have cash equivalents that may be compared. In some embodiments, one or more of the account programs may include offers for discounts or other valuable products or services. In such embodiments, the cash value of rewards points may be compared to the cash value of the offer or discounts in order to determine which account program would provide the greatest benefit to the user for the particular requested transaction. In some embodiments, the merchant involved in the requested transaction may also have provide potential benefits related to the specific transaction or for the issuers corresponding to each respective user payment account. For example, a particular merchant may be offering a discount for certain products purchased with the first user payment account, but not with the second user payment account. In such embodiments, the payment selection system may consider the merchant benefits when determining the first and second potential benefits.

At 316, the payment selection system may compare the first potential benefit to the second potential benefit to determine which of the benefits is greater. In the embodiment shown in FIG. 6, the requested transaction was initiated by the user with the first user payment account. Accordingly, if, at 316, the payment selection system determines that the second potential benefit is not greater than the first potential benefit, the payment selection system may, at 320, complete the requested transaction using the first user payment account. However, if the payment selection system determines, at 316, that the second potential benefit is greater than the first potential benefit, the payment selection system may, at 318, may transmit a request confirmation to complete the requested transaction using the second user payment account instead of the first user payment account. In some embodiments, requesting confirmation may include transmitting, via the digital communication network 60, a confirmation request to the user computing device 55 corresponding to the unique device identifier stored by the payment selection system. In such embodiments, the user may be alerted to the confirmation request and presented with the option to confirm the requested transaction with the second user payment account, or to decline the confirmation. In some embodiments, the confirmation request may display a GUI on the user computing device with selectable options, such as shown in FIG. 5. In some embodiments, if the user declines to confirm the confirmation of using the second user payment account, the payment selection system may, at 320, complete the transaction using the first user payment account. If, however, the user confirms the confirmation request, the payment selection system, at 324, may complete the requested transaction with the second payment account instead of the first payment account. Accordingly, the user may be awarded with the greater rewards benefits associated with the second user payment account as opposed to the first user payment account.

In some embodiments, the payment selection system may complete at least the steps outlined in blocks 310-324 of FIG. 6 in approximately real time with reference to the requested transaction. For example, once a transaction request is transmitted, the user computing device may receive a confirmation request very shortly afterwards, such as within a few seconds or minutes. In some embodiments, it is contemplated that the process described in FIG. 6 and other embodiments may take longer to develop, but may still have the same general outcome. In some embodiments, the payment selection system may automatically select to complete the requested transaction with the payment account associated with the greatest potential benefit without transmitting a confirmation request to the user computing device. In some embodiments, the payment selection system may automatically confirm a switch to a user payment account associated with a greater benefit if the payment selection system does not receive confirmation or denial of the confirmation request within a predetermined length of time, such as thirty seconds, one minute, two minutes, five minutes, ten minutes, or thirty minutes. Likewise, in some embodiments, the payment selection system may automatically reject a switch to a user payment account associated with a greater benefit if the payment selection system does not receive confirmation of the confirmation request within a predetermined length of time, such as thirty seconds, one minute, two minutes, five minutes, ten minutes, or thirty minutes. In such embodiments, the payment selection system may complete the transaction using the user payment account initially included in the transaction request. In some embodiments, the user may pre-select such settings and preferences when enrolling with the payment selection system.

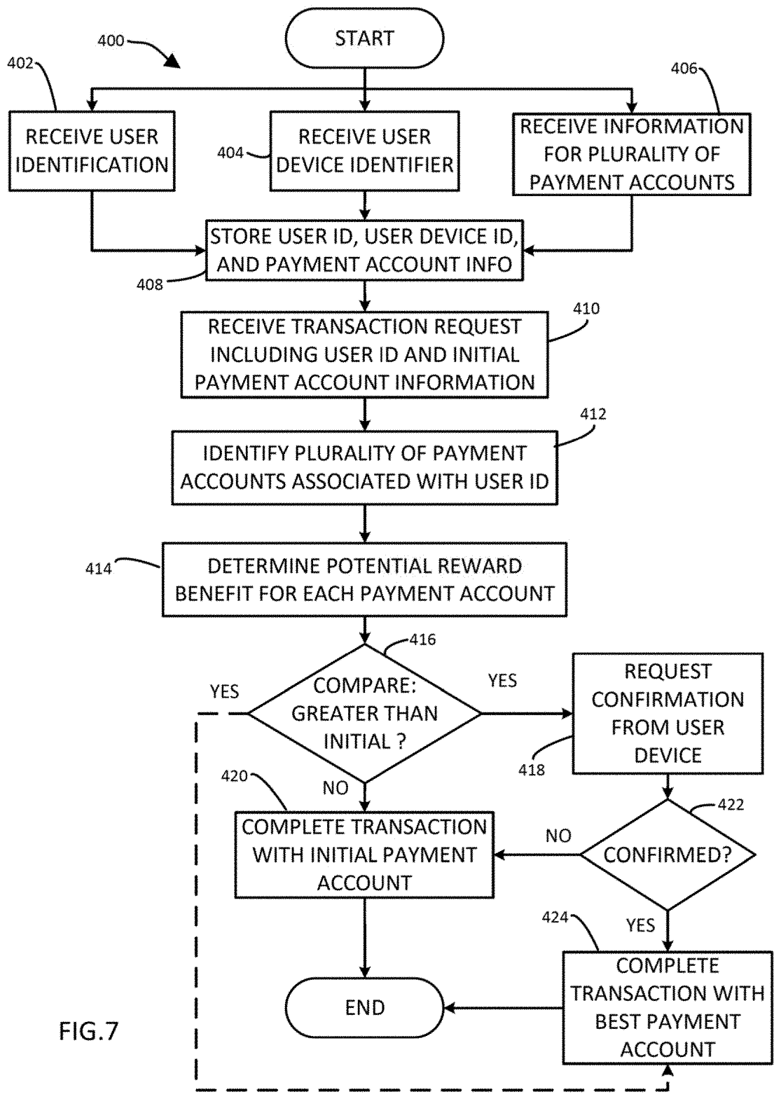

FIG. 7 shows a flow chart of another embodiment 400 of a method of using the payment selection system. During user enrollment, the payment selection system may receive user identification information at 402, a user device identifier at 404, and information payment account information associated with a plurality of user payment accounts at 406. The user device identifier may be associated with a user computing device at which the user would like to receive confirmation requests from the payment selection system. At 408, the payment selection system may store the user identifying information, user device identifier, and payment account information either at the payment server 85, a token server 80, or other suitable location. At block 410, the payment selection system may receive a transaction request that may include user identifying information and initial payment account information. In some embodiments, the initial payment account information may be for a payment account with which the user initiated the requested transaction. At 412, the payment selection system may, based on the user identifying information, identify the plurality of payment accounts associated with the user identifying information. At 414, the payment selection system may determine any potential reward benefits for each of the plurality of payment accounts. At 416, the payment selection system may compare the potential reward benefits to determine which of the plurality of user payment accounts would provide the greatest benefit to the user. If completing the requested transaction with the initial payment account would provide the greatest benefit, the payment selection system may, at 420, complete the requested transaction with the initial payment account. If any other of the plurality of user payment accounts provides a greater potential rewards benefit to the user than the initial payment account, the payment selection system may determine the best user payment account for the requested transaction based on the user payment account that would provide the greatest potential benefit. At 418, the payment selection system may transmit a confirmation request to the user computing device associated with the user device identifier received at 404 requesting confirmation to complete the requested transaction using the best user payment account instead of the initial user payment account. If, at 422, the payment selection system receives a confirmation from the user computing device to use the best user payment account within a predetermined amount of time, the payment selection system may, at 424, complete the requested transaction using the best user payment account. If, at 422, the payment selection system receives a denial of the confirmation request or does not receive a confirmation from the user computing device within a predetermined amount of time, the payment selection system, at 420 may complete the requested transaction with the initial user payment account. In some embodiments, the payment selection system may, as selectable by the user, automatically complete the requested transaction with the best user payment account if no confirmation is received from the user computing device within a predetermined amount of time. In some embodiments, as represented by the dashed line between blocks 416 and 424, the payment selection system may automatically complete the requested transaction using the best user payment account without requesting confirmation from the user or the user computing device.

The various participants and elements described herein may operate one or more computer apparatuses to facilitate the functions described herein. Any of the elements in the above-described Figures, including any servers, user terminals, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++ or Perl using, for example, conventional or object-oriented techniques. In some examples, the at least one processor may be specifically programmed.

The software code may be stored as a series of instructions, or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware and a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed (or physically configured) to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, the system and the methods described herein may be configured to efficiently provide substantially real-time or automatically approvable payment selection to maximize the rewards benefits for a user. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A processor-implemented method for payment selection, the method comprising:
receiving, via a digital communication network, user identifying information associated with a user from a user device;
receiving, via the digital communication network, payment account information associated with a plurality of user payment accounts associated with the user, a first of the plurality of user payment accounts associated with a first account program and a second of the plurality of user payment accounts associated with a second account program;
receiving, via a payment network, transaction request information for a transaction, the transaction request information including the user identifying information of the user and the payment account information for the first of the plurality of user payment accounts;
based on the user identifying information, determining, via one or more processors:
a first potential benefit through the first account program from completing the transaction using the first of the plurality of user payment accounts, and
a second potential benefit through the second account program from completing the transaction using the second of the plurality of user payment accounts;
determining, via the one or more processors, that the second potential benefit is greater than the first potential benefit;
based on the determination that the second potential benefit is greater than the first potential benefit, transmitting, via the digital communication network, a confirmation request to the user device, the confirmation request configured to request that the user confirm that the transaction be completed using the second of the plurality of user payment accounts instead of the first of the plurality of user payment accounts;
receiving, via the digital communication network, a selection of the user to complete the transaction using the second of the plurality of user payment accounts instead of the first of the plurality of user payment accounts; and
based on receiving the selection of the user, completing the transaction with the second of the plurality of user payment accounts.

2. The method of claim 1 further comprising receiving, via the digital communication network, a user device identifier of the user device associated with the user.

3. The method of claim 1, wherein the confirmation request is configured to display a graphical user interface on the user device corresponding to the confirmation request to confirm the transaction.

4. The method of claim 1, wherein the transaction request information further comprises merchant information associated with a merchant, and wherein the method further comprises transmitting a request for offers to a merchant server associated with the merchant and receiving merchant offer information from the merchant server in response to the request for offers.

5. The method of claim 4, wherein determining that the second potential benefit is greater than the first potential benefit is at least partially based on the response to the request for offers received from the merchant server.

6. The method of claim 1, wherein determining that the second potential benefit is greater than the first potential benefit is based at least partially on comparing a first cash value of the first potential benefit with a second cash value of the second potential benefit.

7. The method of claim 1, wherein the first potential benefit is a first number of reward points and the second potential benefit is a second number of reward points, and wherein the determination that the second potential benefit is greater than the first potential benefit is based at least partially on comparing the first number of reward points to the second number of reward points.

8. A processor-implemented method for payment selection, the method comprising:
receiving, via a digital communication network, user identifying information associated with a user;
receiving, via the digital communication network, payment account information associated with a plurality of user payment accounts associated with the user;
receiving, via a payment network, transaction request information for a transaction, the transaction request information including the user identifying information of the user and the payment account information for a first of the plurality of user payment accounts;
based on the user identifying information, determining, via one or more processors:
a first potential benefit from completing the transaction using the first of the plurality of user payment accounts, and
a second potential benefit from completing the transaction using a second of the plurality of user payment accounts;
determining, via the one or more processors, that the second potential benefit is greater than the first potential benefit; and
based at least partially on the determination that the second potential benefit is greater than the first potential benefit, completing the transaction with the second of the plurality of user payment accounts.

9. The method of claim 8 further comprising receiving, via the digital communication network, a user device identifier of a user device associated with the user.

10. The method of claim 9 further comprising:
transmitting, based on the determination that the second potential benefit is greater than the first potential benefit, a confirmation request to the user device requesting that the user confirm use of the second of the plurality of user payment accounts to complete the transaction; and
receiving, from the user device, confirmation to complete the transaction using the second of the plurality of user payment accounts.

11. The method of claim 10, wherein completing the transaction with the second of the plurality of user payment accounts is at least partially based on the receiving, from the user device, confirmation to complete the transaction using the second of the plurality of user payment accounts.

12. The method of claim 8, further comprising:
requesting potential benefit information from a first issuer server associated with the first of the plurality of user payment accounts and a second issuer server associated with the second of the plurality of user payment accounts; and
determining the first potential benefit at least partially based on the potential benefit information received from the first issuer server and the second potential benefit at least partially based on the potential benefit information received from the second issuer server.

13. The method of claim 8, wherein the transaction request information further comprises merchant information associated with a merchant, and wherein the method further comprises transmitting a request for offers to a merchant server associated with the merchant and receiving merchant offer information from the merchant server in response to the request for offers.

14. The method of claim 13, wherein determining that the second potential benefit is greater than the first potential benefit is at least partially based on the response to the request for offers received from the merchant server.

15. The method of claim 8, wherein determining that the second potential benefit is greater than the first potential benefit is based at least partially on comparing a first cash value of the first potential benefit with a second cash value of the second potential benefit.

16. The method of claim 8, wherein the first potential benefit is a first number of reward points and the second potential benefit is a second number of reward points, and wherein the determination that the second potential benefit is greater than the first potential benefit is based at least partially on comparing the first number of reward points to the second number of reward points.

17. A processor-implemented method for payment selection, the method comprising:
receiving, via a digital communication network, user identifying information associated with a user;
receiving, via the digital communication network, a user device identifier associated with a user device of the user;
receiving, via the digital communication network, payment account information associated with a plurality of user payment accounts associated with the user,
receiving, via a payment network, transaction request information for a transaction, the transaction request information including the user identifying information of the user and payment account information for an initial user payment account of the plurality of user payment accounts;
based on the user identifying information, determining, via one or more processors, a potential benefit available for completing the transaction with each of the plurality of user payment accounts;
determining, via the one or more processors, a best user payment account of the plurality of user payment accounts, the best user payment account having a greater potential benefit than the potential benefit of the initial user payment account; and
based at least partially on the determination that the potential benefit of the best user payment account is greater than the potential benefit of the initial user payment account, completing the transaction with the best user payment account of the plurality of user payment accounts.

18. The method of claim 17 further comprising:
transmitting, based on the determination that the potential benefit of the best user payment account is greater than the potential benefit of the initial user payment account, a confirmation request to the user device requesting that the user confirm use of the best user payment account to complete the transaction; and
receiving, from the user device, confirmation to complete the transaction using the best user payment account.

19. The method of claim 17 further comprising determining, via the one or more processors, that the potential benefit of the best user payment account is greater than the potential benefit of any other of the plurality of user payment accounts.

20. The method of claim 17, wherein determining that the potential benefit of the best user payment account is greater than the potential benefit of the initial user payment account is based at least partially on comparing a cash value of the potential benefit of the best user payment account with a cash value of the potential benefit of the initial user payment account.
